(19) United States
(12) Patent Application Publication
(10) Pub. No.: US 2026/0147359 A1
(43) Pub. Date: May 28, 2026

(54) 2D MAP MANAGEMENT BY A ROBOT SWEEPER

(71) Applicant: ViaBot, Inc., Santa Clara, CA (US)

(72) Inventors: John Lee, Sunnyvale, CA (US); Raj Shinde, Santa Clara, CA (US); Yashaarth Todi, Santa Clara, CA (US)

(21) Appl. No.: 19/401,216

(22) Filed: Nov. 25, 2025

Related U.S. Application Data
(60) Provisional application No. 63/725,524, filed on Nov. 26, 2024.

(51) Int. Cl. G05D 1/648; B25J 11/00

(52) U.S. Cl. CPC G05D 1/648; B25J 11/0085

(57) ABSTRACT

A method is provided for generating a two-dimensional map for autonomous navigation by a robot module, including: using sensors of the robot module to sense a local environment and generate a three-dimensional model of the local environment; determining a level of ground throughout the three-dimensional model; setting a minimum height and a maximum height throughout the three-dimensional model, the minimum height being at a first predefined amount above the level of ground, and the maximum height being at a second predefined amount above the level of ground; generating a two-dimensional map by excluding objects from the three-dimensional model that are below the minimum height or above the maximum height, and setting a height of remaining objects to a same height; using the two-dimensional map by the robot module to autonomously navigate the local environment.

### CLAIM OF PRIORITY

This application claims priority to U.S. Provisional Application No. 63/725,524, filed on Nov. 26, 2024, entitled “2D MAP MANAGEMENT BY A ROBOT SWEEPER”, which is herein incorporated by reference.

### RELATED APPLICATIONS

This application is related to U.S. patent application Ser. No. 17/134,102 filed on Dec. 24, 2020 and entitled “SYSTEMS FOR SETTING AND PROGRAMMING ZONING FOR USE BY AUTONOMOUS MODULAR ROBOTS,” and to U.S. Provisional Patent Application No. 63/725,519 (Attorney Docket No. VBOTP006+), filed on Nov. 26, 2024 entitled “MULTI-LAYERED PLANNERS FOR CLOSE ADHERENCE TO EDGES BY A ROBOT SWEEPER,” and to U.S. Provisional Patent Application No. 63/725,522 (Attorney Docket No. VBOTP007+), filed on Nov. 26, 2024, and entitled “MULTI-PURPOSE MISSION PLANNER FOR ROBOT SWEEPER,” the disclosures of which are herein incorporated by reference.

### FIELD

The present disclosure relates generally to systems and methods for two-dimensional map management by a robot sweeper.

### BACKGROUND

Autonomous robots are becoming increasingly prevalent due to their ability to automatically perform a variety of tasks that are typically performed manually by humans, or that have been performed with direct human control of a machine. An example of an autonomous robot is a robotic sweeper which can be used to clean surfaces such as the parking surface of a parking lot. Such robots are often programmable, allowing users to configure operation times, frequency of operation, and various other settings for the robots. Once programmed, the robots may perform a task, move, and interact with the surrounding environment without requiring further human input. However, challenges remain in providing optimal autonomous navigation of a robot.

It is in this context that embodiments of the disclosure arise.

### SUMMARY

Methods, systems, and computer systems are provided for two-dimensional map management by a robot sweeper.

Broadly speaking, for onboard processing efficiency, implementations of the present disclosure provide for a two-dimensional (2D) map to be generated from three-dimensional (3D) modeling of a property. The 2D map is used for path/route planning for the robot sweeper. The 2D map can be updated based on detection of changes or objects when sweeping. The robot sweeper collects 3D sensor data during operation which can be uploaded for analysis, and AI recognition can be used to identify persistent or permanent changes warranting updates to the map, as opposed to temporary changes which may be ignored.

During path mission planning, the map is divided into subsections, and the planned route is oriented along the longest side of each subsection to minimize the number of turns. Large or multi-floor properties may be covered by several maps which are connected to each other. Route planning can entail finding the most efficient route across multiple maps (e.g. from a home base on one of the maps to a target location on another one of the maps).

In some implementations, a user interface for map edits can enable a user to draw special zones (e.g. color-coded), which have specifically defined robot sweeper behaviors associated therewith.

In some implementations, a method is provided for generating a two-dimensional map for autonomous navigation by a robot module, including: using sensors of the robot module to sense a local environment and generate a three-dimensional model of the local environment; determining a level of ground throughout the three-dimensional model; setting a minimum height and a maximum height throughout the three-dimensional model, the minimum height being at a first predefined amount above the level of ground, and the maximum height being at a second predefined amount above the level of ground; generating a two-dimensional map by excluding objects from the three-dimensional model that are below the minimum height or above the maximum height, and setting a height of remaining objects to a same height; using the two-dimensional map by the robot module to autonomously navigate the local environment.

In some implementations, the three-dimensional model is defined by a point cloud, wherein points in the point cloud identify surfaces in the local environment.

In some implementations, excluding objects from the three-dimensional model is defined by excluding points in the point cloud that are below the minimum height or above the maximum height.

In some implementations, the maximum height being at the second predefined amount above the level of ground is configured to exclude objects that are above a height of the robot module.

In some implementations, the sensors include one or more of LIDAR, radar, sonar, an ultrasonic sensor, or a camera.

In some implementations, the method further includes applying a recognition model to sensor data generated by the sensors to recognize an object in the local environment; labeling a representation of the recognized object in the two-dimensional map.

In some implementations, the labeled representation of the recognized objects triggers a predefined behavior when the robot module is proximate to the object in the local environment.

In some implementations, using the two-dimensional map by the robot module to autonomously navigate the local environment includes using the two-dimensional map to generate a path for the robot module to autonomously traverse.

In some implementations, autonomously traversing the path includes generating a sequence of waypoints along the path and autonomously navigating the robot module through the sequence of waypoints.

In some implementations, the autonomous navigation of the local environment is configured to include performing cleaning of the ground of the local environment during the autonomous navigation.

In some implementations, a method is provided for dispatching a robot module to a target location, including: receiving a command to perform an operation by the robot module on a property; responsive to receiving the command, then retrieving a plurality of maps of the property, each map representing a different portion of the property, and each map sharing a border with at least one other of the maps; determining a plurality of potential paths for traversing from a start location in a first one of the maps, to a target location in a second one of the maps, and determining costs associated with each of the potential paths; selecting one of the potential paths having a minimal cost associated therewith; navigating the robot module along the selected path from the start location to the target location.

In some implementations, the potential paths include paths that traverse from the first one to the second one of the maps via different ones of the maps.

In some implementations, determining costs associated with each of the potential paths includes determining costs of traversing the different ones of the maps.

In some implementations, determining costs associated with each of the potential paths is based on one or more of a distance required by each potential path, an amount of turning required by each potential path, or a current date or time.

In some implementations, the start location is defined by a location of a docking station for the robot module.

In some implementations, the target location is defined by a location for initiating an operation for performance by the robot module.

In some implementations, the operation is a cleaning operation.

The foregoing is a summary of certain embodiments in accordance with implementations of the disclosure. It will be appreciated that other embodiments and implementations will be realized upon a full understanding of the present disclosure.

### BRIEF DESCRIPTION OF THE DRAWINGS

FIG. 1 illustrates a high level diagram of a robot module that is designed for a sweeping work function, in accordance with one embodiment.

FIG. 2 conceptually illustrates a process for generating a two-dimensional map using a three-dimensional model of a local environment, in accordance with implementations of the disclosure.

FIG. 3A conceptually illustrates a plurality of maps which are connected to each other, in accordance with implementations of the disclosure.

FIG. 3B conceptually illustrates the various possible routes traversing various maps, in accordance with the implementation of FIG. 3A.

FIG. 3C conceptually illustrates selection of an optimal crossover point for switching from one map to another, in accordance with the implementations of the disclosure.

FIG. 4A conceptually illustrates route optimization for traversing a plurality of maps representing a plurality of floors, in accordance with implementations of the disclosure.

FIG. 4B conceptually illustrates selection of a route via ramps between floors, in accordance with the implementation of FIG. 4A.

FIG. 5 conceptually illustrates a map with special zones defined for which robot settings or behavior are specifically defined, in accordance with implementations of the disclosure.

FIG. 6 conceptually illustrates componentry of a robot module, in accordance with implementations of the disclosure.

The drawings are provided to illustrate examples of embodiments and are not intended to limit the scope of the disclosure. In addition, features in the drawings are not necessarily to scale.

### DETAILED DESCRIPTION

Methods and systems for controlling operation by autonomous modular robots are disclosed. The methods include hardware and/or software systems that are used to interface with and control operation of an autonomous modular robot that is programmed to perform a task. Broadly speaking, the autonomous modular robot may be referred to by a number of names, such as, the robot (module), the modular robot, the (robot) sweeper, the scrubber, the autonomous vehicle, the vehicle, the cutter, the mower, the autonomous unit, and other similar names. The modular robot can therefore be configured to perform different tasks, or work functions. These tasks can include, without limitation, ground cleaning, floor source cleaning, ground scrubbing, ground vacuuming, sweeping of paved surfaces (e.g. parking lots, buildings, roads, etc.), or other types of outdoor or indoor surfaces or spaces. In one example, the modular robot may be configured for sweeping. Such a configuration may include a robot, a sweeper module, and a dock assembly.

The robot is mobile (e.g., has wheels or tracks), and is configured to engage and retain the sweeper module, and maneuver the sweeper module over a given surface to be cleaned. The sweeper module is a modular unit having brushes that sweep debris from the surface into an included collection container. If the work function is to scrub a surface, a scrubber module may be picked up by the robot instead of a sweeper module. The same applies to a mower module, which can be picked up from a respective docking station to enable mowing of a lawn, shrubs, or grass.

In order to facilitate efficient autonomous navigation of a robot module, implementations of the present disclosure provide methods and systems for generating, managing, and utilizing two-dimensional maps. A 2D map is generated based on a 3D modeling of a local environment. Coverage of a given mapped area, for example for purposes of cleaning/sweeping the area by the robot module, is achieved through generation of paths using the map. In some implementations, a property is divided into multiple maps, and traversal of the robot module from one location to another may entail optimizing the route across multiple maps.

These and other features described herein will now be further described with reference to the following drawings.

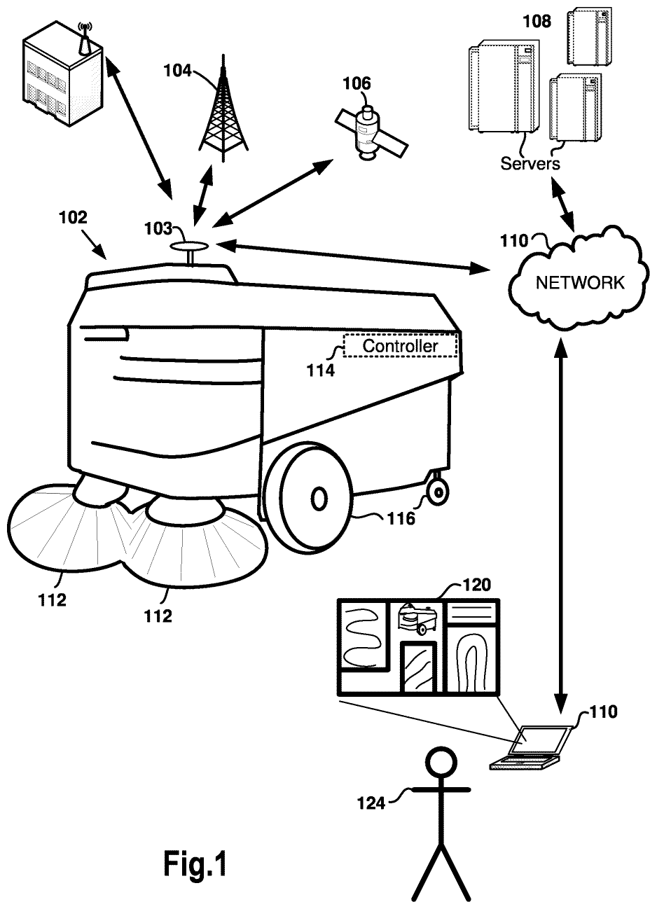

FIG. 1 illustrates a high level diagram of a robot module 102 that is designed for a sweeping work function, in accordance with one embodiment. As shown, the robot module 102 includes brushes 112, which are utilized to sweep debris collected from surfaces, such as parking lots, hard surfaces, buildings, and the like. In one embodiment, the robot module 102 includes a sweeping module (not shown) which is contained within the robot module 102, and the sweeping module is connected to the brushes 112. For more information on the modular interface between the robot module 102 and the sweeping module, reference may be made to U.S. Provisional Patent Application No. 63/087,179, filed on Oct. 3, 2020, which is herein incorporated by reference. The robot module 102 includes one or more antenna 103, which is used by the robot module 102 to communicate wirelessly with one or more different types of communication devices. In one embodiment, the antenna 103 can include the communications device for communicating with the network 110.

The communications device can be an Ethernet controller that allows for Wi-Fi or cellular connection to the network 110. In some embodiments, high-speed cellular can be utilized for the communication, such as 5G communication. In some embodiments, the antenna 103 can be configured to communicate with a cell tower 104, or multiple cell towers 104 for enabling the communication with the network 110. In some embodiments, the GPS transponder can be provided in the robot module 102, to enable communication with a global positioning system (GPS) device 106. The robot module 102 may also communicate with local GPS 106a, for higher precision economist movement. Broadly speaking, GPS coordinates obtained from a GPS 106 may not provide sufficient precision and movement when the robot module 102 is required to perform fine tune movements, based on the work function.

The local GPS 106a, for example, may be installed at the location where the robot module 102 is to perform its work function. As mentioned above, mapping data can be generated for a location to enable the robot module 102 to move efficiently about the location in which the work function is to be performed. Network 110 is shown communicating with servers of a data center 108. The servers 108 may be replicated among one or more data centers depending on the location of the robot module 102 and the desired communication with those robots. For example, robot modules 102 operating in California may utilize local region data centers 108, and robot modules 102 operating in New York may utilize local region data centers 108 to reduce delay. As will be described in greater detail below, the servers of the data center may be utilized to communicate instructions to the robot modules 102. The instructions provided to the robot module 102 can include information for defining zones at specific locations, where the robot module 102 is to perform its work function.

The instructions can be custom tailored by the manager of the location where the robot module 102 is to perform its work function. In some embodiments, the manager is the user 124, which has access to a computer 110 for visualizing the location where the work function is to be performed. The user interface 120 may be provided which highlights the layout of the location, and allows for the user 124 to customize the zones to be used to perform the work functions. The robot module 102 is shown to include wheels 116 to enable the robot module 102 to function in its autonomous movement. The autonomous movement of the robot module 102 can be customized based on a schedule, and can be customized to allow the user 124 to define different work functions to be performed in different zones of a location being managed. The controller 114 of the robot module 102 includes electronics that provide for autonomous movement of the robot module 102, and interfacing with electronics of the sweeper module being used by the robot module 102.

The robot module 102 includes batteries to enable electric vehicle movement and operation, and the sweeper module included in the robot module 102 will also include batteries for providing power to perform the work function. In one embodiment, the robot module 102 is configured to be docked at a docking station, where the robot module and its batteries can be charged.

The robot module 102 uses one or more of a number of guiding technologies for autonomous movement, such as GPS, local GPS, cameras for vision assisted movement, LIDAR, radar, sonar, ultrasonic proximity sensors, depth cameras, or combinations of two or more thereof.

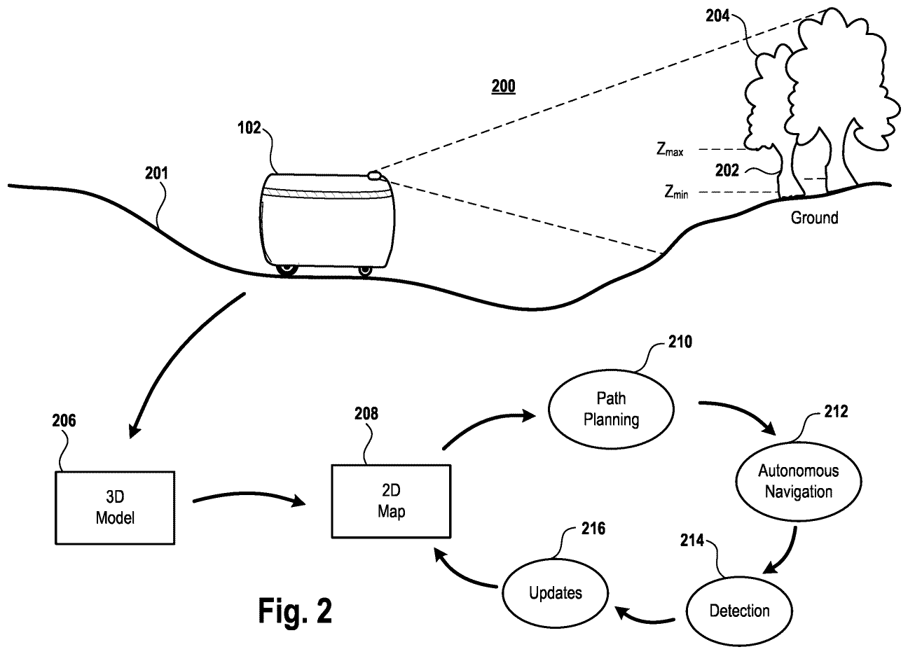

FIG. 2 conceptually illustrates a process for generating a two-dimensional map using a three-dimensional model of a local environment, in accordance with implementations of the disclosure.

In the illustrated implementation, the robot module 102 scans a local environment 200, which can be a region of space for traversal by the robot module, such as a parking lot or other property or paved structure for sweeping by the robot module in some implementations.

To begin, the robot module 102 performs a three-dimensional (3D) scan of the local environment 200 using one or more sensors (e.g. LIDAR, sonar, cameras, etc.). The output of the 3D scan is a 3D model 206 of the local environment. In some implementations, the 3D model 206 is defined by a pointcloud which describes the 3D surface structures of objects in the local environment.

In order to process the 3D model 206 into a two-dimensional (2D) map 208 for use in navigational routing/planning by the robot module 102, several processing operations are performed. First, the vertical level of the ground 201 is determined throughout the pointcloud. It will be appreciated that the level of the ground 201 throughout the local environment 200 may vary as the surface of the ground 201 may exhibit contours deviating from a flat level. In some implementations, the level of the ground at a given location is determined as the Z-value of the lowest point in the point cloud at that location.

Then throughout the point cloud, a vertical range above the level of the ground is set, and points outside of the vertical range are excluded. The vertical range is configured to encompass the height range within which the robot module is expected to encounter objects in the environment. Thus, broadly speaking, the vertical range is set between a level slightly above the ground level, and a level that is at or slightly above the height of the robot module 102 relative to the ground level. In some implementations, a vertical minimum (Zₘᵢₙ) and a vertical maximum (Zₘₐₓ) are set throughout the point cloud, and points below the vertical minimum or above the vertical maximum are excluded. In some implementations, the vertical minimum is defined at a level that is slightly above the level of the ground at a given location, such as an amount in the range of about 0 to 5 cm above the level of the ground in some implementations, or about 1 to 3 cm in some implementations, etc. In some implementations, the vertical maximum is defined at a level that is at or slightly above the height of the robot module 102 relative to the ground level. For example, the vertical maximum can be defined at level that is greater than the height of the robot module 102 (relative to ground level) by about 0 to 0.5 meters in some implementations, or about 0.1 to 0.4 meters in some implementations, etc.

By setting the vertical range and excluding points outside of the vertical range as has been described, then the ground is removed from the point cloud, and objects that the robot module will not encounter (because they are above its height) are also removed. For example, with continued reference to FIG. 2, there may be a tree in the local environment 200, and by setting the Zₘᵢₙ and Zₘₐₓ as shown, then the lower trunk portion 202 of the tree is retained in the data as this will be encountered by the robot module 102. However, the upper canopy portion 204 of the tree is excluded as it will not be encountered by the robot module and can be safely ignored. It will be appreciated that various types of elevated artifacts will be excluded in this manner, such as tree leaves, lamps, roofs, etc.

After points falling outside of the vertical range are excluded/removed/clipped, then the Z values of the remaining points are set to the same height (e.g. zero), or Z values are simply removed, effectively flattening the point cloud to form a 2D map 208. The resulting 2D map 208 can be utilized for path planning and real-time navigation of the robot module 102.

In some implementations, the process of generating the 2D map 208 further includes applying a recognition model to recognize objects in the local environment, and the recognition of such objects is leveraged in the process of generating the 2D map. For example, the sensor data from the robot module can be analyzed by the recognition model to recognize objects in the local environment, and the resulting object representations in the 2D map can be automatically tagged or labeled according to their recognized object type. Then during operations of the robot module in the local environment using the map, these labels/tags may automatically trigger predefined behaviors by the robot module. For example, a curb might be recognized in the local environment and then labeled as such in the map, and when the robot module is performing cleaning in the vicinity of the curb, then the robot module may be configured to closely adhere to the curb, and perhaps contact the curb sidewall with its sweeper brushes, or slow its speed to a predefined limit.

In some implementations, the recognition can enable distinguishing between ground surface regions at substantially the same or a similar level, but which are distinct from each other and ought to be regarded differently by the robot module. For example, a paved area might be continuous with a non-paved area (e.g. dirt, grass, gravel, etc.), and it is desired for the robot module to clean the paved area and but not the non-paved area. Accordingly, the recognition process may recognize the non-paved area as distinct from the paved area, and automatically label/tag the non-paved area as a region of the map which will not be cleaned by the robot module. In some implementations, such a region can be designated so that the robot module avoids traveling into the region.

In some implementations, there may be paved areas which are continuous with each other, yet one should be avoided by the robot module while the other is permissible for the robot's traversal. For example, a paved portion of a parking lot may be continuous with a pedestrian walkway or ramp, which is also paved (possibly with a distinct material). The pedestrian walkway/ramp can be recognized and automatically labeled as such, and this may configure the labeled area to be avoided by the robot module so that it does not travel on the pedestrian walkway/ramp despite it being continuous with the parking lot.

In some implementations, the map 208 is updated based on detection of the local environment by the robot module 102 during its operations, such as during carrying out cleaning operations in the local environment. For example, in some implementations, the map 208 is utilized for path planning operations 210, during which a path for the robot module 102 to traverse is planned. Then the robot module 102 perform autonomous navigation operations 212 in order to traverse the planned path. It will be appreciated that as the robot module navigates the local environment, detection 214 of the local environment is carried out by scanning the local environment using the robot module's sensors and analyzing the sensor data captured by the robot module's sensors. For example, a recognition model can be applied to the sensor data to enable recognition of objects or activity occurring in the local environment. It will be appreciated that the analysis of the sensor data can be carried out by the robot module or remotely (e.g. by uploading the sensor data for analysis by a remote device, such as a remote computer, cloud computing server, etc.).

The detection of the local environment can be configured to distinguish between temporary and permanent changes, and the permanent changes can be used to perform updates 216 on the map 208, while the temporary changes are not used to update the map. For example, a parked vehicle might be detected in the local environment (and is not reflected on the map), and the recognition of the parked vehicle as such enables the system to ignore it for purposes of determining whether any updates to the map 208 are needed, as the parked vehicle is a temporary change in the local environment that does not trigger an update. By contrast, installation of an electric vehicle charger in the local environment could be recognized as a permanent change, and as such, its detection may trigger an update to the map 208 to reflect its installation. Thus, as different types of objects appear in the local environment, that are not included in the map and which may be permanent or temporary, their recognition may or may not trigger updating the map 208 to reflect their presence, based on the recognized type of object.

It will be appreciated that when a detected object triggers an update to the map, then a similar process to that described above can be employed. As has been described, this may include setting minimum and maximum heights for the object's point cloud representation, excluding points which lie outside the minimum and maximum heights, and setting the height of the remaining points to zero. In some implementations, the representation of the object in the 2D map can be automatically labeled/tagged with the type of the object that has been recognized.

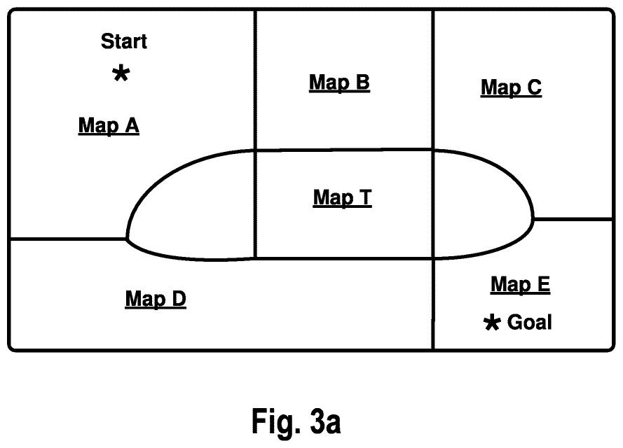

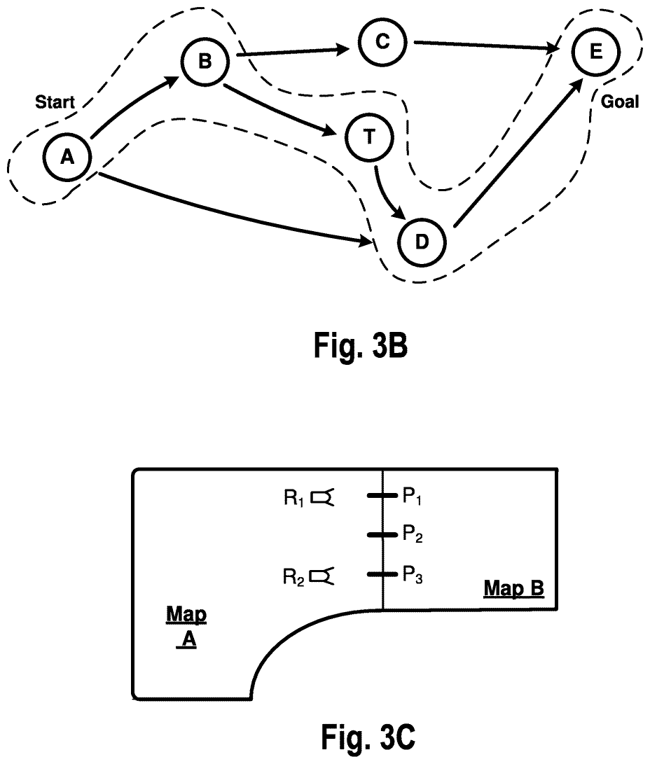

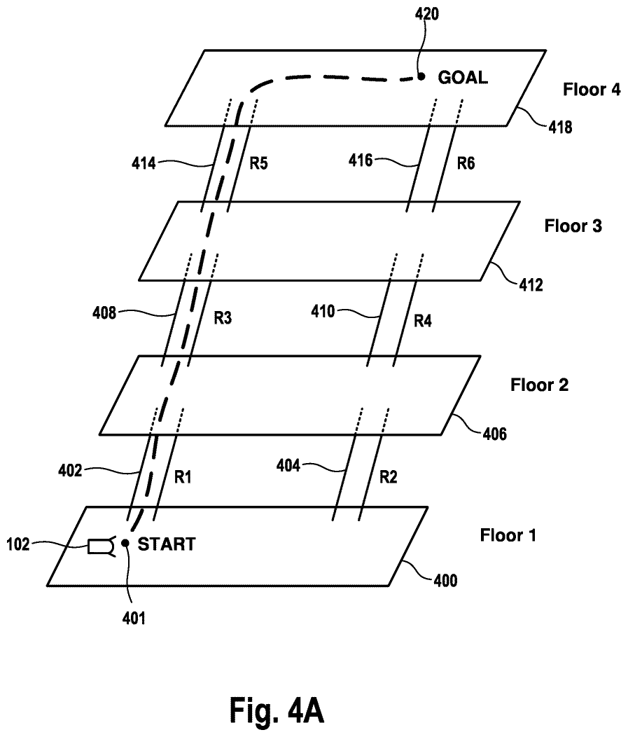

FIG. 3A conceptually illustrates a plurality of maps which are connected to each other, in accordance with implementations of the disclosure.

In some implementations, a given property may be represented by multiple 2D maps, with each map representing a different portion of the property. Some of these maps may border one another or connect to each other in some way (e.g. via pathways, driveways, ramps, etc.).

With reference to the illustrated implementation of FIG. 3A, various maps are shown which collectively represent a given property, including Map A, Map B, Map C, Map D, Map E, and Map T representing different portions of the property. The maps which are adjacent to each other represent portions of the property that connect to each other. For example, Map A is adjacent to Map B, and thus it is possible to traverse between Map A and Map B along (at least a portion of) their shared border.

It may be necessary for the robot module to move between portions of the property that are not directly connected/adjacent to each other. In other words, it may be necessary to move the robot module from one portion of the property represented by a first map, to another portion represented by a second map that is not connected to the first map. In such situations, in order to find the optimal efficient route for the robot to travel between maps, the robot module performs a cost analysis to determine the optimal route.

For example, in the illustrated implementation, suppose that it is necessary to move the robot module from a start location in Map A to a goal location in Map E. For example, the robot may be situated at a robot dock in Map A, and need to be dispatched to perform a job in Map E, such as performing cleaning of a section of Map E. Then a cost analysis of various possible routes traversing the various maps from Map A to Map E is performed, and the lowest cost route is chosen as the route to be traveled by the robot module 102.

FIG. 3B conceptually illustrates the various possible routes traversing various maps, in accordance with the implementation of FIG. 3A.

Possible routes as shown include the following map traversal sequences: (going from map) A to B to C to E; A to B to T to D to E; A to D to E.

The total cost of a given route is the sum of the costs of traversing from each map to the next in the sequence. Thus the total cost for the first of these routes is as follows:

$$cost ( A to B to C to E ) = cost ( A to B ) + cost ( B to C ) + cost ( C to E )$$

Whereas the total cost of the second of these routes is:

$$cost ( A to B to T to D to E ) = cost ( A to B ) + cost ( B to T ) + cost ( T to D ) + cost ( D to E )$$

And the total cost of the third of these routes is:

$$cost ( A to D to E ) = cost ( A to D ) + cost ( D to E )$$

In the illustrated implementation, it may be determined that the second of the routes (A to B to T to D to E) is determined to have the lowest total cost, and is therefore chosen as the optimal route to be traveled by the robot module. Despite requiring traversal across the highest number of maps, the cost is minimized by selecting this route, making it the most efficient route for maneuvering the robot module from the start location to the goal location.

It will be appreciated that the cost of a given traversal can be defined based one or more factors such as the distance of travel required, the time of travel required, the amount of turns or directional changes required, the time of day, the day of the week, etc. In some implementations, the cost increases as the distance of travel required increases. In some implementations, the cost increases as the time of travel required increases. In some implementations, the cost increases as the amount of turns or directional changes required increases. In some implementations, a given map, or portion thereof, may be more costly to traverse at certain times than at other times, and thus the cost may increase or decrease based on the time of day, and/or the day of the week, whether it is a holiday, the current season, etc. For example, a particular parking lot represented by a given map may be more likely to be busy during working hours, and therefore more costly to traverse during working hours than at other times.

It will be appreciated that in some implementations, the cost of traversing a given map can be included in the cost of traversing from a preceding map to the given map, and/or included in the cost of traversing from the given map to a succeeding map.

FIG. 3C conceptually illustrates selection of an optimal crossover point for switching from one map to another, in accordance with the implementations of the disclosure.

In some implementations, there may be multiple points at which the robot module may crossover from one map to another. For example, there may be multiple pathways, driveways, ramps, doorways, openings, or other structures that enable the robot module to travel from a location in one map to a location in another map. In such implementations, then the cost analysis can include determining the optimal pathway for switching from one map to another.

For example, in the illustrated implementation, Map A and Map B are again shown, but with three distinct pathways P1, P2, and P3 shown, which represent possible pathways for traversing from Map A to Map B. In some implementations, the robot module is configured to choose the closest pathway for traversing from Map A to Map B. Thus, if the robot module is positioned at location R1 in Map A, then it will choose pathway P1 to traverse from Map A to Map B. Whereas if the robot module is positioned at location R2 in Map A, then it will choose pathway P3 to traverse from Map A to Map B. In so doing, the robot module selects the nearest pathway to navigate in order to optimize the traversal from Map A to Map B.

It will be appreciated that in various implementations, distance/proximity of a pathway, as well as other factors such as those enumerated above in relation to cost analysis, may be used to select the optimal pathway. And further, the various pathways can have associated costs which are used in determining the cost of a given route as described above. For example, the cost of traversing from one map to another can include the associated cost of traversing a given pathway between the maps. In some implementations, optimizing the route of the robot module can include determining costs associated with traversing between maps via different possible pathways, and minimizing the overall cost of the route accordingly.

In further implementations, two adjacent maps may share a continuous open portion along their border, and travel between the maps at any point along the continuous open portion is possible. In a similar manner as described previously, the selection of the specific point along the continuous open portion at which to cross from one map to the other, can be optimized so as to minimize the overall cost of the route.

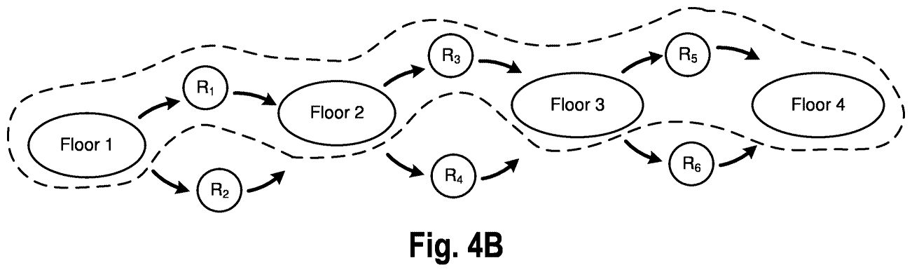

FIG. 4A conceptually illustrates route optimization for traversing a plurality of maps representing a plurality of floors, in accordance with implementations of the disclosure.

In the illustrated implementation, a plurality of maps including map 400, map 406, map 412, and map 418 are shown. Each of the maps represents a floor of a structure, such as a parking garage. For example, map 400 represents the first floor; map 406 represents the second floor; map 412 represents the third floor; and, map 418 represents the fourth floor. Also shown are various ramps connecting between the floors of the structure. Ramps R1 and R2 connect between map 400 and map 406; ramps R3 and R4 connect between map 406 and map 412; and, ramps R5 and R6 connect between map 412 and map 418.

It may be necessary to navigate the robot module 102 from the first floor to the fourth floor, and thus a route is planned to travel from a start location 401 in map 400 to a goal/end location 420 in map 418. Accordingly, as the robot module can traverse from one map to another via the various ramps, a route is planned that minimizes the overall cost of traversing the maps via the ramps.

FIG. 4B conceptually illustrates selection of a route via ramps between floors, in accordance with the implementation of FIG. 4A.

As shown, various routes utilizing the various ramps are possible in order to navigate the robot module from the first floor to the fourth floor. To travel from the first floor to the second floor, it is possible to take ramp R1 or R2; to travel from the second floor to the third floor, it is possible to take ramp R3 or R4; and, from the third floor to the fourth floor, it is possible to take ramp R5 or R6. Accordingly, the cost of traveling from the first floor to the fourth floor via each possible combination of ramps is determined, and the lowest cost route can be selected for implementation by the robot module.

As described previously, cost can be determined based on one or more factors, such as distance required, time required, amount of directional change required, date/time, etc.

By way of example without limitation, in the illustrated implementation, it may be determined that the path which minimizes the cost of traveling from the start location 401 on the first floor to the goal location 420 on the fourth floor is defined by a path that includes taking the ramp R1 from the first floor to the second floor, then taking the ramp R3 from the second floor to the third floor, and then taking the ramp R5 from the third floor to the fourth floor.

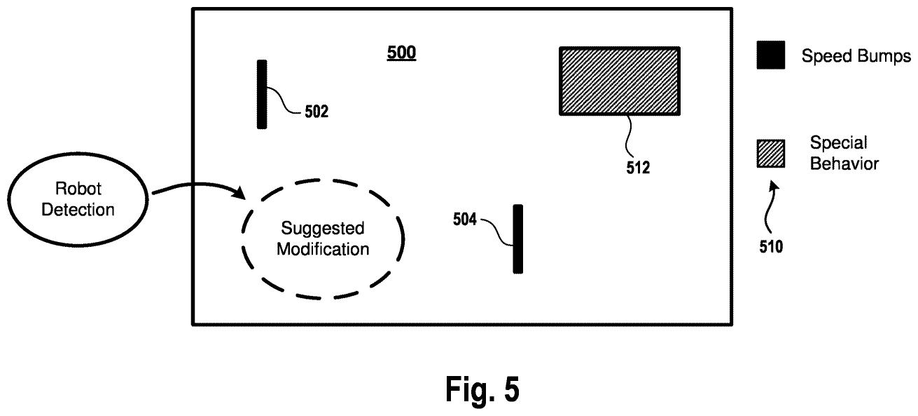

FIG. 5 conceptually illustrates a map with special zones defined for which robot settings or behavior are specifically defined, in accordance with implementations of the disclosure.

In some implementations, it is desirable to define custom robot behaviors for particular zones of a map. For example, in the illustrated implementation, a map 500 is shown with certain zones 502 and 504 defined therein, which correspond to speed bumps in the mapped property. In some implementations, a custom behavior is defined for the zones 502 and 504 to aid the robot in handling the speed bumps, such as setting a reduced speed (or speed limit for the robot), and turning off the sweeper module of the robot. In this manner, when the robot navigates into zone 502 or zone 504 as indicated on the map 500, then the robot will slow its speed and turn off its sweeper module. Upon exiting zone 502 or 504, the robot's regular behavior may resume, by increasing its speed and turning on the sweeper module, for example.

Thus, a map can be customized with special zones than trigger a customized behavior when the robot module enters such zones. In some implementations, a user interface is provided through which a user may define customized behaviors and set zones for which the customized behaviors will apply. For example, with continued reference to the illustrated implementation, a user may set a custom behavior and associate a particular color or pattern 510 with the custom behavior. Then, by drawing a region 512 in the map 500 and setting the region 512 to the color/pattern 510, then the region 512 is set to trigger the custom behavior when the robot module enters the region 512.

In further implementations, the system may automatically suggest custom behavioral zones to the user. For example, in some implementations, during operation of the robot module within the property, it may sense objects or characteristics of the environment, or activity occurring therein, which are recognized using a recognition model (e.g. a machine learning or artificial intelligence model). Based on the detection of such objects or characteristics or activity, the system may suggest, through its user interface, certain predefined custom behaviors to set for the regions of the map at which the objects/characteristics/activity are present. It will be appreciated that boundaries of such objects/characteristics can be automatically determined based on the detection as well.

For example, the robot module might recognize an area as having high pedestrian traffic, such as by recognizing pedestrian crossing markings on the ground/pavement, or recognizing persons walking in the area (e.g. on a repeated basis, or at certain times), and the system may suggest slowing/limiting the speed of the robot for such an area. Or as another example, the robot module might detect an area prone to having high amounts of debris/trash, such as by recognizing a waste dumpster or other waste collection container, and therefore the system may suggest a higher intensity cleaning mode for the area, such as by setting slower speeds, narrower spacing between adjacent paths/passes of the robot module, increased power/suction by a vacuum mechanism, increased speed of a rotating sweeping brush, increased downforce applied by a sweeping brush, etc.

In another implementation, the robot module may recognize a construction area or other area that should be avoided, and the system may suggest setting the area as a special zone to be avoided by the robot module. In some implementations, the robot module may continue to verify if the area exists during subsequent operational runs, and if it is detected that the area no longer exists, then the system may recommend through the user interface to remove the special zone.

In some implementations, a given special zone may have a time-associated variable component associated therewith. For example, a pedestrian zone identified as discussed above might be determined to have high amounts of pedestrian traffic during certain hours, but low amounts of pedestrian traffic during other hours. And accordingly, the pedestrian zone may be configured with customized behavior tailored to the different hours of pedestrian traffic. For example, the pedestrian zone may be configured so that the robot module is limited to lower speeds in the pedestrian zone during the hours of high pedestrian traffic, while higher speeds are permitted during the hours of low pedestrian traffic. This is one example of a setting varying with time for a particular zone, and it will be appreciated that in various implementations other settings of the robot module's operation can be configured to vary based on time.

In some implementations, the robot module may detect the absence of a feature from its local environment, and the system may be configured to recommend removal of the feature's associated special zone. For example, if the robot module detects that a speed bump has been removed, then the system can be configured to recommend removal of a corresponding special zone in the map. Or in a related implementation, the robot module may detect a modification of a feature in the local environment, and the system may be configured to recommend adjustment of the feature's associated special zone.

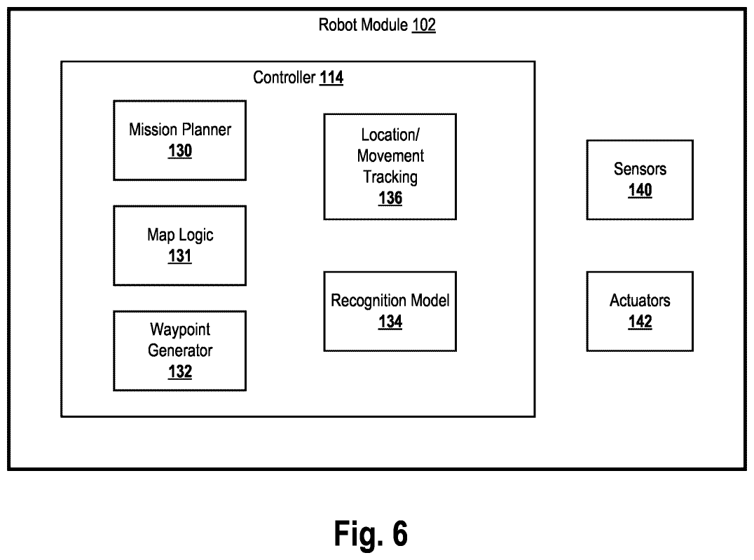

FIG. 6 conceptually illustrates componentry of a robot module, in accordance with implementations of the disclosure.

The robot module includes a controller 114, which can include hardware and software configured to control the operation of the robot module 102, including its movements as described herein. The controller 114 includes a mission planner 130 that generates paths for the robot module to traverse, as described herein. For example, such paths may traverse multiple maps in an optimized manner. The mission planner 130 may access a map logic 131 to retrieve a map of a given area for which to generate paths, and/or provide updates to a given map. The mission planner 130 may access a waypoint generator 132 to generate waypoints for the robot module to navigate in order to traverse, at least approximately, a given path.

In some implementations, the map logic 131 is configured to perform various map-related functions including those described in the present disclosure, such as generating a map of a local environment, setting special zones within the map, etc.

The robot module includes various sensors 140 that sense characteristics of the local environment in which the robot module is disposed, and/or characteristics of the robot module's movements or location. In some implementations, sensor data generated by one or more of the sensors 140 is processed by a recognition model 134 to enable recognition of objects in the local environment, such as curbs, roads, parking lot surfaces, vehicles (e.g. car, truck, motorcycle, etc.), persons, trash, etc. In some implementations, the sensor data and/or output of the recognition model 134 is used by a location/movement tracking logic 130 to determine the location and/or movement of the robot module 102. It will be appreciated that the determined location and/or movement of the robot module can be used as feedback to the global planner and the local planner, to enable continued generation of waypoints and velocities in accordance with the implementations of the present disclosure.

The robot module 102 further includes various actuators 142, which are controlled to move the robot module 102 according to the generated velocities by the local planner.

The robot module 102 may include one or more antennas, and can include cameras integrated into the body regions. In some embodiments, the cameras may be integrated to the sides of the outer body of the robot module to enable a 360 degree view. In one configuration, the top portion of the body may open to expose or grant access to electronics associated with the controller 114, electronics for interfacing with batteries of the sweeper module in the robot module 102, and other devices. Some electronics related devices may include processors, microcontrollers, system-on-a-chip processors, application specific integrated circuits (ASICs), memory modules, hard drives, solid state drives, network interface cards, radio communication devices, cellular transceivers, associated operating systems, controller boards, lights, plugs, circuit boards, connection wiring, and associated assemblies.

Other devices, without limitation, may include (without limitation) control systems for cameras, depth cameras, radar, LIDAR, motion sensors, depth sensors, ultrasonic sensors, heat sensors, motion sensors, strain sensors, motor sensors, locking sensors, lifting sensors, docking sensors, and other operational or interfacing sensors. In some embodiments, the wheel configuration can be interchanged, depending on the surface the robot is designed autonomously move about. For example, some wheels may be off-road if the vehicle is used on dirt roads or on farms, or harder surface wheels used in parking lots or smooth surface. In other embodiments, instead of wheels, loop rubber tracks can be used for more off-road operation.

Though in implementations of the disclosure described above, a robot module 102 has been discussed, it will be appreciated that in other implementations, other types of exchangeable modules having different functions can be attached to the robot. For example, a lift mechanism of the robot can be used to attach and retain interchangeable modules/attachments for performing different work functions. The exchangeable modules are physical apparatus structures that may each be configured to perform a unique task, e.g., steam cleaning, vacuuming, grass cutting, polishing, buffing, driveway and/or street cleaning (e.g., sweeping), package grasping and/or moving, etc. In some embodiments, the interchangeable attachments may be configured to perform complementary tasks. For example, for cleaning a floor, the first interchangeable attachment may be configured to vacuum the floor and the second interchangeable attachment may be configured to steam clean the floor.

In some implementations, the interchangeable attachments may be automatically loaded and unloaded from the robot one or more dock assemblies (or docking stations or base stations). The loading and unloading may be performed autonomously, with the robot automatically aligning itself and loading or unloading an interchangeable attachment as needed to accomplish the job assignment that the robot has been programmed to perform.

In some embodiments, the vertical movement of attachments achieved via a lift mechanism of the robot may be utilized as part of performing a task and/or to accommodate interchangeable attachments of different sizes. For example, in the case of a sweeper module the lift mechanism can be utilized to lift the sweeper module to a height required to remove the sweeper module from the dock assembly. The lift mechanism can also be used to lower the sweeper module to the appropriate height for carrying out sweeper operations, such as a height at which the brushes of the sweeper module fully contact the floor.

In some implementations, the robot includes a controller that is configured to control the autonomous functions of the robot. For example, the controller can control the motors which effect movement of the wheels of the robot to move the robot in its operations, such as to control movement of the robot over the sweeper module, and move autonomously along a path to capture debris into the container of the sweeper module. Further, the controller can control the robot's lift mechanism to lower the lift frame over the sweeper module to connect the alignment pegs with the alignment holes, control the locking mechanism to secure the lift frame to the sweeper module, and control the lift mechanism to raise the lift frame along with the sweeper module toward the interior space of the robot. It will be appreciated that the controller may control these operations in reverse so as to lower the lift frame along with the sweeper module, to seat the sweeper module onto the alignment platform, unlock the sweeper module so as to release the sweeper module, control the lift mechanism to raise the lift frame without the sweeper module, and move the robot off of the dock assembly while leaving the sweeper module at the dock assembly, for example, to allow the sweeper module to charge its battery or be serviced otherwise.

It will be appreciated that in some implementations, the robot includes a battery for powering its motors, lift mechanism, sensory systems, and other electronic systems. The sweeper module can also include a battery for powering the sweeper module, such as powering rotation of its brushes. In some implementations, a battery controller handles sharing of power between the robot's battery and the sweeper module's battery. The battery controller can be implemented as part of the robot or the sweeper module, or partially implemented on both the robot and the sweeper. In some implementations, power from the sweeper module's battery can be shared to the robot to, for example, charge the robot's battery, power the robot's motors, lift mechanism, locking mechanism, sensors, communications, etc. Likewise, in some implementations, power from the robot's battery can be shared to the sweeper module to, for example, charge the sweeper module's battery, power the sweeper module's brushes, etc.

In some implementations, the battery of the sweeper module is significantly larger than the battery of the robot, as the sweeper module is retained at the docking station and subject to charging for greater periods of time. Hence, the battery of the sweeper module can be implemented as the primary power source for the sweeper module as well as the robot, and therefore used to power the functions of both units.

In some implementations, when the sweeper module is connected to a docking station, and the robot is connected to the sweeper module, then the battery controller can route power to effects charging of one or both of the sweeper module's battery and the robot's battery. It will be appreciated that the battery controller routes power received from the docking station through the sweeper module to the robot, in order to provide power to the robot to charge its battery.

In some implementations, the robot includes a plurality of cameras and a global positioning system (GPS) for controlling movement of the robot by the controller. In some implementations, the robot uses one or more cameras to align with a visible code located at the dock system as described above, and images of the visible code are processed by the controller for guiding the robot to align with the dock system when the robot approaches the dock system for pickup or release of the sweeper module.

Advantageously, robots according to various embodiments disclosed herein may run indefinitely, with the robot constantly swapping batteries and interchangeable attachments as the need arises and as job assignments change. As a result, the robot may function as a home cleaning robot, a commercial cleaning robot, an outdoor robot, an indoor robot, etc. which may autonomously change its abilities without the need of human interaction (e.g., from grass cutting with a grass cutting attachment, to moving bins and crates of an adapter for supporting bins and crates, to cleaning driveways with a vacuum and/or sweeping attachment). An example of the operation of the robot is provided below. It will be appreciated that the sequence below may be performed in the order shown. In addition, omissions of certain actions and/or changes in the order of various actions are also contemplated.

The robot may start off at a charging base station with an interchangeable attachment (e.g., a sweeper module) locked to the main chassis or body of the robot through its retention system. The robot may start off with a power supply (e.g., a removable battery) already in place. The robot heads out of the charging base to perform its assignment (in this case sweeping). When the robot is finished with the assignment (finished sweeping a given area), or when the interchangeable attachment is filled to capacity (e.g., when a sweeper module is filled with debris) the robot will return to the base station or another designated drop area, and detach the interchangeable attachment. The detachment may occur via unlock and pushout of the attachment, or by dropping the attachment under the force of gravity. The robot aligns itself to the interchangeable attachment, or wherever the retention adapters are among the interchangeable attachments, moves towards the interchangeable attachment, centers itself (e.g., using sensors such as a camera) and the retention system locks/unlocks the interchangeable attachment as desired. When the robot approaches the base/charging station, at a certain distance it starts a docking procedure.

The robot maintains a docking distance from the base station to help itself align to the back of the modular box as well as to the retention system before the robot docks. This docking procedure exists in both retaining and detaching the interchangeable attachments at a designated area or a base/charging station. The base station may help guide the robot via sensors and buttons to dock at the base station and aligned with the retention system. In other words, the base station may provide guidance for the robot to return to the station. In addition, the station may include an actuator that shifts the position of the interchangeable attachment to align with the retention system of the robot. The robot may move towards and locate the base station with a variety of sensors, such as live feed cameras, infrared or other proximity sensors, ground sensors, or line detection sensors that are able to follow “tracks” which may be provided on the ground along the path which the robot is to traverse. The tracks may be, e.g., anything from tape that is sensed by the robot, paint sensors disposed or integrated into a surface, or sensors embedded at specific locations in the ground. The use of tracks in one embodiment is optional, since the robot will be able to use its cameras and sensors to navigate and avoid obstacles. The robot may use a variety of sensors such as live feed cameras and/or infrared or other proximity sensors to help locate, and load and unload the interchangeable attachments at a base station or other designated area.

The robot may move to an empty location (e.g., at the base station or at a designated area) and detach its interchangeable attachment. Preferably, this detachment occurs at the location the interchangeable attachment was originally picked up from, e.g., at the space left open when the component was earlier retained by the robot. The robot may then move to another interchangeable attachment for another task. For example, the robot may align itself with a steam cleaning interchangeable attachment located at the base station (e.g., next to or around the vacuum interchangeable attachment), and pick up the steam cleaning interchangeable attachment via the retention system, and then move away from base station to perform the steam cleaning task. In some other embodiments, both the vacuum attachment and the steam cleaning attachment may be loaded onto the robot such that vacuuming and steam cleaning maybe performed without requiring the robot to return to the base station to switch attachments.

The robot can navigate with the help of GPS, in addition to other location devices not positioned on the robot itself or the base station to help with returning to an interchangeable attachment for docking and undocking. These location devices may include Bluetooth beacons or infrared light emitters. In cases where the robot is equipped with a modular, removable power supply, the power supply may be unloaded and a new power supply may be loaded in a procedure similar to the unloading and loading of interchangeable attachments. For example, where the robot has performed various tasks and its attached battery is running low, the robot may: move to a base station containing a charged or charging battery, unload a depleted battery at the base station or designated area, and load another battery.

In cases where the robot is not equipped with a modular, removable power supply, the robot may use a variety of sensors to return to the base station for recharging. The robot may return to the base station to recharge, head off to finish its job, or remain at the base station depending on whether a job assignment has been completed. The robot may be charged while retaining an interchangeable attachment. For example, such charging may be performed via connectors built into the robot that send signals and power to both the interchangeable attachments and the robot's main computer system. In some embodiments, charging may occur without the robot retaining any interchangeable attachment.

It will be appreciated that the interchangeable attachment may be tracked by the robot using shape/color or design. Such tracking may be utilized to align to the robot for unloading and loading the interchangeable attachment.

It will be appreciated by those skilled in the art that various omissions, additions and modifications can be made to the processes and structures described above without departing from the scope of the invention. For example, it will be appreciated that the robot has been shown without any side panels or other housing around the functional illustrated components. In some embodiments, a housing or shell may be provided around the illustrated components e.g., to protect these functional components from collisions of external objects, weather, or other external phenomena that may damage these functional components.

In addition, the housing may maintain a consistent external appearance and size/shape to the robot, irrespective of the sizes of the interchangeable attachments or the number of retained attachments. This may provide aesthetic benefits and/or allow a consistent interface with other devices external to the robot (e.g., a base station) irrespective of modifications to the internal components or interchangeable attachments. In addition, while various components have been illustrated and discussed as being placed at different locations, it will be appreciated that the relative locations of the various compliments may be varied while still maintaining the functionality disclosed herein.

It is contemplated also that various combinations or sub-combinations of the specific features and aspects of the embodiments may be made and still fall within the scope of the description. Various features and aspects of the disclosed embodiments can be combined with, or substituted for, one another in order.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention could employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. The computer readable medium can also be distributed over a network-coupled computer system so that the computer readable code is stored and executed in a distributed fashion.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for generating a two-dimensional map for autonomous navigation by a robot module, comprising,
using sensors of the robot module to sense a local environment and generate a three-dimensional model of the local environment;
determining a level of ground throughout the three-dimensional model;
setting a minimum height and a maximum height throughout the three-dimensional model, the minimum height being at a first predefined amount above the level of ground, and the maximum height being at a second predefined amount above the level of ground;
generating a two-dimensional map by excluding objects from the three-dimensional model that are below the minimum height or above the maximum height, and setting a height of remaining objects to a same height;
using the two-dimensional map by the robot module to autonomously navigate the local environment.

2. The method of claim 1, wherein the three-dimensional model is defined by a point cloud, wherein points in the point cloud identify surfaces in the local environment.

3. The method of claim 2, wherein excluding objects from the three-dimensional model is defined by excluding points in the point cloud that are below the minimum height or above the maximum height.

4. The method of claim 1, wherein the maximum height being at the second predefined amount above the level of ground is configured to exclude objects that are above a height of the robot module.

5. The method of claim 1, wherein the sensors include one or more of LIDAR, radar, sonar, an ultrasonic sensor, or a camera.

6. The method of claim 1, further comprising:
applying a recognition model to sensor data generated by the sensors to recognize an object in the local environment;
labeling a representation of the recognized object in the two-dimensional map.

7. The method of claim 6, wherein the labeled representation of the recognized objects triggers a predefined behavior when the robot module is proximate to the object in the local environment.

8. The method of claim 6, wherein using the two-dimensional map by the robot module to autonomously navigate the local environment includes using the two-dimensional map to generate a path for the robot module to autonomously traverse.

9. The method of claim 8, wherein autonomously traversing the path includes generating a sequence of waypoints along the path and autonomously navigating the robot module through the sequence of waypoints.

10. The method of claim 8, wherein the autonomous navigation of the local environment is configured to include performing cleaning of the ground of the local environment during the autonomous navigation.

11. A method for dispatching a robot module to a target location, comprising:
receiving a command to perform an operation by the robot module on a property;
responsive to receiving the command, then retrieving a plurality of maps of the property, each map representing a different portion of the property, and each map sharing a border with at least one other of the maps;
determining a plurality of potential paths for traversing from a start location in a first one of the maps, to a target location in a second one of the maps, and determining costs associated with each of the potential paths;
selecting one of the potential paths having a minimal cost associated therewith;
navigating the robot module along the selected path from the start location to the target location.

12. The method of claim 11, wherein the potential paths include paths that traverse from the first one to the second one of the maps via different ones of the maps.

13. The method of claim 12, wherein determining costs associated with each of the potential paths includes determining costs of traversing the different ones of the maps.

14. The method of claim 11, wherein determining costs associated with each of the potential paths is based on one or more of a distance required by each potential path, an amount of turning required by each potential path, or a current date or time.

15. The method of claim 11, wherein the start location is defined by a location of a docking station for the robot module.

16. The method of claim 11, wherein the target location is defined by a location for initiating an operation for performance by the robot module.

17. The method of claim 16, wherein the operation is a cleaning operation.
